(19) United States
(12) Patent Application Publication
(10) Pub. No.: US 2023/0115654 A1
(43) Pub. Date: Apr. 13, 2023

(54) CONTEXTUAL TRIGGER-BASED TEMPORARY ADVISOR MATCHING SYSTEM AND METHOD

(71) Applicant: Wells Fargo Bank, N.A., San Francisco, CA (US)

(72) Inventors: Kathy McLeod Balding, Matthews, NC (US); Meghan A. Duthie, Charlotte, NC (US); Robin Leavitt, Charlotte, NC (US); Gwendoria M. Salley, Rock Hill, SC (US); Spencer Holland Touchberry, Fort Mill, SC (US)

(21) Appl. No.: 16/011,256

(22) Filed: Jun. 18, 2018

(51) Int. Cl. G06Q 10/06; G06Q 30/00; G06Q 30/02; H04L 29/08

(52) U.S. Cl. CPC G06Q 10/063112; G06Q 10/063114; G06Q 30/016; G06Q 30/0239; H04L 67/306

(57) ABSTRACT

Disclosed herein is a method and related system for providing assistance to a user of a service provider (SP). The method comprises receiving and storing user background information for a user in a user database in a memory of the SP, the background information comprising user account information that is accessible by the SP. The method further comprises receiving and storing temporary advisor (TA) information for a plurality of TAs in a TA database in the memory. A matching engine determines an occurrence of a trigger event related to the user account information. Responsive to the trigger event, the method comprises storing user current information in the user database, matching the user with one or more TAs of the plurality of TAs for an interaction, communicating, with the user, information related to the matched TA(s) for an interaction, and receiving and storing interaction information related to the interaction.

### TECHNICAL FIELD

Described herein is a computer-based sy stem and related method that matches a user with a temporary advisor of a service provider based on a trigger and the context of that trigger.

### BACKGROUND

In many business relationships, it may be beneficial for a service provider or a service provider to assign a dedicated advisor to a user so that the user always has a point of contact to ask questions, seek advice, and engage in other commercially beneficial communications.

In a particular situation that is used as a use case herein, the service provider is a financial service provider, and the services tend to revolve around investment-related activities. In a traditional long-term investment relationship between a user and a service provider that is a financial institution, users may be broken down into two broad categories. First, those having a dedicated advisor assigned to them who provides full financial advice (where the advisor is generally involved in any substantive decisions related to the user’s investments and is familiar with the user’s situation and goals). Second, those who are self-directed (where the user is generally responsible for their own investment decisions). This breakdown may typically relate to the total value of assets being invested, since the provision of a traditional dedicated advisor providing full financial advice often requires a significant allocation of resources which may only make economic sense for larger asset portfolios (although other criteria may be utilized to delineate between these two categories).

Since providing a dedicated advisor may consume a significant amount of business resources that are warranted only in cases in which the user is likely to provide a corresponding benefit in return, many businesses establish thresholds or criteria below which no dedicated advisor is assigned. Nonetheless, users not meeting the dedicated advisor threshold criteria may still benefit from interactions with an advisor, and the service provider may still benefit providing an advisor under certain circumstances or with certain limitations in place-leaving self-directed users without any access to a advisor may be disadvantageous to both the user and the financial institution

### SUMMARY

Disclosed herein is a computer-implemented method for providing assistance to a user of a service provider (SP). The method comprises, using a processor, receiving and storing user background information for a user in a user database in a storage device of the SP, the background information comprising user account information that is accessible by the SP. The method further comprises receiving and storing temporary advisor (TA) information for a plurality of TAs in a TA database in the storage device. The method uses a matching engine that uses the processor for determining an occurrence of a trigger event related to the background and current user information. When the trigger event is determined to have occurred, and responsive to the trigger event, the method comprises storing user current information in the user database, matching the user with one or more TAs of the plurality of TAs for an interaction based on a set of matching criteria, communicating, with the user, information related to the one or more matched TAs for an interaction, and receiving and storing interaction information related to the interaction.

Disclosed herein is also a service provider (SP) sy stem comprising: a hardware processor, and a non-volatile storage device-based storage device connected to the hardware processor comprising instructions that, when executed on the processor, configure the processorto: receive and store in the storage device user background information for a user in a user database in a storage device of the SP, the background information comprising user account information that is accessible by the SP. The instructions further configure the processor to receive and store in the storage device temporary advisor (TA) information for a plurality of TAs in a TA database in the storage device. The system further comprises a matching engine that uses the hardware processor of the SP to determine an occurrence of a trigger event related to the user account information. When the trigger event is determined to have occurred, and responsive to the trigger event, the processor is configured to store user current information in the user database, match the user with one or more TAs of the plurality of TAs for an interaction based on a set of matching criteria, communicate, with the user, information related to the one or more matched TAs for an interaction, and receive and store, in the storage device, interaction information related to the interaction.

A non-transitory comp uter-readable storage medium, is further disclosed, comprising instructions that when executed by a processor, cause the processor to execute the above-described method.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a block diagram illustrating an example implementation of the matching sy stem.

FIG. 2 is a flowchart that illustrates a process flow that may be utilized in the system shown and described above with respect to FIG. 1.

FIG. 3 is a timeline/state diagram that illustrates the various states the user and the temporary advisor might go through.

FIG. 4 is a block diagram illustrating an example of a machine that may be a computer on which various processes described herein may be performed.

FIG. 5 is a block diagram of an example of a distributed computing system within which various processes described herein may be performed.

### DETAILED DESCRIPTION

Described below is an advisor matching sy stem that matches a user and a temporary advisor based on a particular context or event. For the sake of clarity, example implementations may be discussed as illustrations. However, the invention is not limited to such implementations.

As noted above, even though a user may not meet the criteria that warrants having a dedicated advisor, there may be some benefit to providing limited advice in some limited, cost-effective, and economical manner to self-directed users that balances the amount of resources expended on such users while still benefitting both on the user and the service provider. Such limited advice may be offered to self-directed users on an as-needed basis, for example. However, in order to maximize the technical resources of both the user and the service provider, an effective and efficient matching must be made between the user and advisors matched to the user by the service provider and that such matching be performed on the basis of a trigger.

In one design, a user may pay a fixed fee for access to a pool of temporary advisors who may be available and willing to help under certain situations. For example, a user may subscribe at $250/year for inclusion in an “temporary advisor pool program” (which is what the system that implements the inventive concept will be referred to below) that allows them access to available temporary advisors under some set of conditions. The price could vary based on an investment portfolio value or according to some other criteria, such as asset accumulation potential related to an inheritance, education (e.g, obtaining a degree in a high-paying field), etc. In addition to simply providing access by users passively, e.g., the user takes the initiative to engage a temporary advisor, the temporary advisor pool program could provide access in an active manner, e.g., the system may contact the user based on some form of a trigger. Thus, it may be possible to provide a user with a temporary advisor who can address certain issues or situations with a user in a cost-efficient manner.

In order to implement the use of temporary advisors, the service provider may reserve a pool of temporary advisors that can be matched with the user in a particular situation or with regard to a particular issue. The matching may be triggered in a particular context or with regard to a certain event related to the user’s prior relationship with the service provider, and in this situation, the engagement between the user and advisor is of a temporary nature for a limited duration.

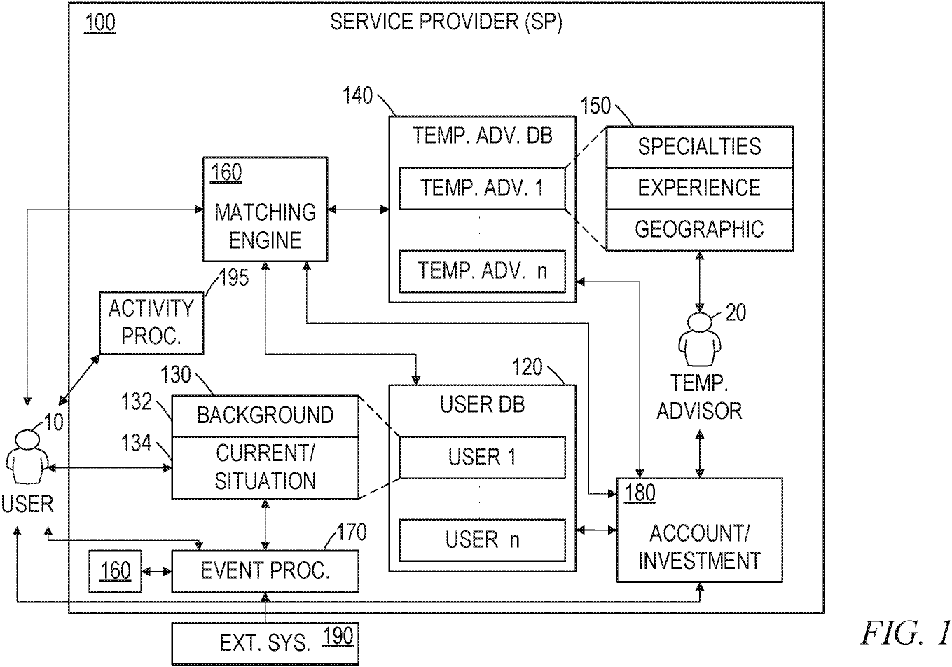

FIG. 1 is a block diagram illustrating an example implementation of the matching system. In this system, the user 10 may have an existing relationship with a service provider 100 or service provider, and information about the user may be kept in a user database 120 along with the information of other users. In an example use case, the service provider 100 is a provider of investment services and the user 10 is an investor or account holder with the service provider 100. A user record 130 containing information about the user 10 may include user background information 132, such as identification and contact information, information about the user’s 10 accounts or investments 180, or goals may be included. Such background information 132 may be obtained when the user 10 establishes the business relationship with the service provider 100. In the example user case, the user 10 may establish various bank accounts and/or investment accounts with the investment service provider 100, and the background information may contain account numbers, information about account content such as shares of stock or mutual funds, savings amount, etc.

The user record 130 may additionally include user current information 134 that may include information about an existing situation that the user 10 is in or is tied to an event that has recently occurred. In addition to this information, the user current information 134 may include GPS/current location information of the user 10, calendar information of the user 10, etc. An event processor 170 may determine that some form of trigger event has occurred either based on accessing information from an external system 190, such as a third-party or related other service provider, an employer, a news feed, a social media feed and the like, or from based information from inside of the service provider, such as an account or investment of the user 180. An expiration of a periodic timer may constitute a trigger event.

As an example of an external input, a news story about Company X that may impact the company’s Stock X value that is held by the user 10 may be obtained from a news feed external system 190 and the event processor 170 determines that this news story is a trigger event. Another example of an external input may be information provided by a related bank of a large deposit placed in an external bank account owned by the user 10. Other trigger events may be a family marriage or new child, retirement, or other family-related happening that might suggest the user 10 may want some kind of a consultation.

An example of an internal event may be the user 10 selling off a number of shares in Stock X held in their investment account 180, the user 10 withdrawing a large amount of cash from their savings account, receipt of an automobile loan application from the user 10, or paying off a loan. In each of these situations, various detection mechanisms may be utilized by the event processor 170 to determine when a trigger event occurs. Additionally, the user 10 themselves may trigger an event by contacting the service provider 100 and requesting assistance with a particular situation.

The service provider 100 may also provide the services of temporary advisors 20 who may be matched with the user 10 to deal with a particular situation or event. The temporary advisors 20 are intended to be advisors to the user for a limited duration of time, based on some pre-arranged criteria, such as may be spelled out in a service contract. For example, the user might pay an annual fee of $1000 in order to be able to make use of a temporary advisor 20 at six different times throughout the year for a duration of one day each time. The annual fee might also allow the event processor 170 to provide the user 10 with notifications for things that the user may wish to interact with the temporary advisor 20 about.

Various information may be provided about the temporary advisors 20 in a temporary advisor database 140, with a database record 150 containing information related to a particular temporary advisor 20. This information may include things like specialties, amount of experience, geographic location (e.g., the temporary advisor 20 being physically close to the user 10 or branches/outlets used by the user 10), hobbies and external interests, etc. Any information may be stored in the database record 150 that allows the advisor to deal with a situation or event related to the user or that may facilitate a better match between the user 10 and the temporary advisor 20. More skilled or more experienced temporary advisors 20 may be assigned at a higher cost or for shorter durations of time for a given dollar amount.

The event processor 170 may be activated when, e.g., the user 10 logs into their account, and the trigger event may be based on what the user 10 is looking at within the service provider 100 (e.g., their investment portfolio) or possibly based on user 10 searches external to the service provider 100 (e.g., a web-based search for a particular mutual fund). In the latter situation, the user 10 may opt in to allow the collection of data based on web searches, social media data, and the like.

When the event processor 170 detects a trigger event, it may store current or situation-related information regarding the trigger event into the current or situation-related data 134 of the user record 130. For example, if the event processor 170 detects a large deposit of $100 K into the user’s 10 savings account 180, it may infer the likelihood of the user 10 receiving an inheritance or a work-related bonus.

Next, the event processor 170 may invoke the matching engine 160 to query the temporary advisors database 140 to determine one or more of the temporary advisors 20 who might be a good fit for handling the situation associated with the trigger event, for example, the large deposit noted in the use case above. In this case, the matching engine 160 may look at matching criteria for temporary advisors who specialize in handling inheritances. In another scenario, the user 10 may contact the service provider 100 and request the assistance of a temp orary advisor 20 to help with how to best handle a given situation, such as the received $100 K in the use case. The user contact could then serve as the event trigger to invoke the matching engine 160 to pair the user 10 up with one or more temporary advisors 20.

In another embodiment, the matching engine 160 is not invoked in response to detecting the trigger event, but rather the user 10 is initially contacted to determine a level of interest in working with a temporary advisor, and the matching engine 160 is only invoked if the user indicates a positive desire to work with a temporary advisor 20. The user 100 contact may be general or specific, depending either on user-indicated preferences or intelligent processes that may determine a success rate for various approaches. For example, in response to detecting a large deposit that may be related to an inheritance, the service provider may communicate in a general manner “Investment strategies for long-term investing”, or in a more specific manner, “We noticed you recently deposited a large amount in your savings account and wondered if you would like some advice on how to make the best use of this money.”

The matching engine 160 may utilize any type of analy sis, such as a weighted factor-based analysis, to determine whether a particular temporary advisor 20 may be a good fit both for the user 10 and the current situation or event. The factors may be arbitrarily or empirically initially established based on research. Additionally, the weights may be initially set to arbitrary or empirically determined values based on research as well. However, the weights and the factors themselves may be constantly adjusted based on feedback received, as discussed herein. For example, if a particular factor appears to have no bearing whatsoever on the success of the interaction over time, its weight may be gradually reduced until it is zero (at which point the factor may be removed altogether). However, if a particular factor appears to significantly influence the success of the interaction, its weight may be gradually increased until its relevance is fully accounted for based on measured feedback.

As noted in the use case above, a large cash deposit into a savings account is often (but not alway s) the result of receiving an inheritance, and thus temp orary advisors with backgrounds in handling estates may be favored. However, other factors in the temporary advisor’s database record 150 may be utilized as well. For example, if the user background data 132 lists a number of the user’s goals, then a temporary advisor 20 who is familiar with such goals may be a good fit. Factors such as geographic proximity to the user may be taken into account in the event that in-person meetings with the temporary advisor 20 may be necessary. Other non-business type factors may be taken into consideration by the matching engine 160, such as user 10 hobbies or recreational interests, demographics, personality profile information (e.g., Meyers-Briggs), etc. Also, availability of a particular temporary advisor 20 may be included in the database record 150. For example, even if a temporary advisor 20 may be a good fit for a given user 10 in a particular situation, it would do no good to recommend that temporary advisor 20 if she will be on vacation when her help is needed.

The matching engine 160 may be configured to present a single temporary advisor 20 to the user 10 that it determined as a “best fit”, or it may be configured to present a list of temporary advisors 20 to the user, via, e.g, the user interface of an app or a web browser, in some form of order, such as a ranked order in terms of “best fit”. The user interface may make use of an app that can be downloaded to their mobile device or PC, or may be accessible via a web browser or other form of a user-server architecture described below. When such a list is presented to the user, the user may select from the list, using a selection device such as a mouse, keyboard, or touch screen of a user device, the temporary advisor 20 that they wish to work with. It may also be possible that the user 10 ranks or rates temporary advisors 20 that they have worked with previously, and that these user ratings are taken into account in the weighted factor analysis for determining the advisor.

The experience level of the temporary advisor 20 may be taken into account and utilized based on any number of factors, such as a detected complexity of the event (e.g., a detected inheritance may be more complex than a detected car loan), or the amount of payment that the user 10 has payed to the service provider 100. In one implementation, the matching engine 160 may utilize artificial intelligence to determine when a match was a good match and when the match was a poor match and adjust the weighting factors accordingly. This determination may be made directly by receiving a user rating of the temporary advisor 20 in the situation/event handling, or it may be inferred by detecting user actions with respect to temporary advisor 20 recommendations.

For example, in one implementation, if the temporary advisor 20 recommendation is to purchase 1000 shares of a mutual fund (the recommendation information may be stored, e.g., in the user record 130) and the user 10 responseis to withdraw the inheritance money from a savings account 180 and close down the account, then it may be inferred that this was a negative interaction and a temporary advisor rating that may be stored in the temporary advisor record 150 may be adjusted downward. In contrast, if the user 10 response is to use the inheritance money to purchase the recommended 1000 shares of the mutual fund, then it may be inferred that this was a positive interaction, and the temporary advisor rating may be adjusted upward.

The matching engine 160 may utilize interaction data from other users stored in the user database 120 in order to make better matches. For example, even though a particular temporary advisor 20 does not have estate matters listed as a specialty, if a number of users 10 have indicated a favorable interaction on estate matters historically, then that temp orary advisor 20 may be chosen by the matching engine 160 to handle an estate matter for a current user 10. It is possible that under certain circumstances, the temp orary advisor 20 is a bot or an intelligent computer-based agent. A computer-based bot as a temporary advisor 20 may had different types of information associated with it in its database 140 record 150, but functionally, the service provider 100 system may operate in the same way. A computer-based bot may be a good alternative where the trigger event typically suggests simple and routine actions on the part of the user 10, such as preparation of loan application papers.

In one implementation, the event processor 170 or the matching engine 160 may determine that the user 10 does not have an advisor and has not registered for the temporary advisor plan. In such an instance, the service provider 100 may provide the user 10 details about the plan, providing the user 10 with an opportunity or offerto sign up—and may perform the matching with a temporary advisor(s) 20 before or after acceptance of the offer.

After the matching engine 160 has run and presented the user 10 with a temporary advisor 20 or a list of temp orary advisors 20, the user may indicate whether they wish to work with a selected temporary advisor 20 and transmit an indication of this to the service provider 100. The matching engine 160 may then either provide information to the user 10 so that the user may contact the temporary advisor 20, or provide information to the temporary advisor 20 so that the temporary advisor may contact the user 10. The user 10 may indicate, either in the background information 132 or after being presented with a potential temporary advisor(s), may indicate a preferred way of communicating with the temporary advisor 20. Such ways may include email, chat, on-line video, in-person, etc. It may be that for a given service agreement between the user 10 and service provider 10, various forms of communication are not available. For example, a low-end service agreement might not allow for an in-person discussion (without, possibly, payingan extra fee). The matching engine may also prompt the user 10 to provide additional information relevant to the event that may be usable by the temporary advisor 20, such as surrounding information related to the $100 K deposit into savings in the use case described above, and this information may be stored in the current/situation information 134 of the user 10. The additional information may be collected in any manner, such as via a survey or on-line questionnaire.

The contact between the user 10 and the temporary advisor 20 may begin with an electronic interaction in which the temporary advisor 20 may provide advice or recommendations to the user 10 with regard to the event that triggered the matching. The temporary advisor 20 may have access to some or all of the data in the user record 130 as well as the user’s 10 accounts and investments 180. It may also be possible that the temporary advisor 20 has some indication, provided by the matching engine 160, as to the basis for the matching with this particular user. In one example, the temporary advisor 20 may note that one of the factors for the matching was a common interest in sports or philanthropy. In this way, the temporary advisor 20 may use that information for a brief discussion about, e.g., the local baseball team or a particular charitable organization during a telephone call.

Information associated with the temporary advisor 20 during the interaction may be stored in the current/situation information 134 of the user. Additionally, information about conditions for the expiration of the interaction may be stored in this information 134 as well. Conditions for the expiration of the interaction may be based on time (e.g., after a specified time and possibly based on the expiration of a timer that is set at the beginning of the interaction), condition (e.g, a detected or pre-specified condition, such as the termination of a telephone call between the user 10 and the temporary advisor), or express termination of the interaction by the user 10.

The temporary advisor 20 may transmit, over a network connection, detailed notes to an electronic user device so that the user may subsequently refer to them in follow-on actions. In one implementation, it may be possible for the advisor 20 to provide, in the notes or via some other user-interface-based mechanism, links, buttons, or other time and effort saving mechanisms for the user 10 to implement the recommendations. For example, if the recommendation is to transfer $100 K in funds from one user account 180 to another, then to the extent that such a transfer can be initiated via a hyperlink, button press, or other simple interface mechanism, such a mechanism may be included in the detailed notes or other communications provided to the user 10.

At some predetermined point, the interaction is considered to be concluded. This predetermined point may be the provision of a recommendation by the temporary advisor 20 to the user. In the above use cases, this may be a recommendation to purchase shares in a particular mutual fund with inheritance money or a completed car loan form that was filled out with the assistance of the temporary advisor 20.

Once the interaction has concluded, the user 10 may or may not decide to take some form of action based on the interaction. An activity processor 195 may be provided to detect activity (or inactivity) related to advice or a recommendation of the temporary advisor 20. Inactivity may be determined based upon pre-defined criteria for when various types of activity may have been expected to take place. Although not shown in FIG. 1, the activity processor 195 may have an interface to the user records 130 in the user database 120, the accounts and investments 180 of the user 10, and the temporary advisor database 140. This permits the activity processor 195 not only to detect, receive, and store information related to the interaction, but to perform any type of analysis based on it, such as an analysis to determine the effectiveness of a particular match, as described above. In one implementation, the user 10 may be provided with an incentive for performing the recommended action, such as a cash-back reward, credit towards services that the service provider 100 provides, including the future services of a temporary advisor 20.

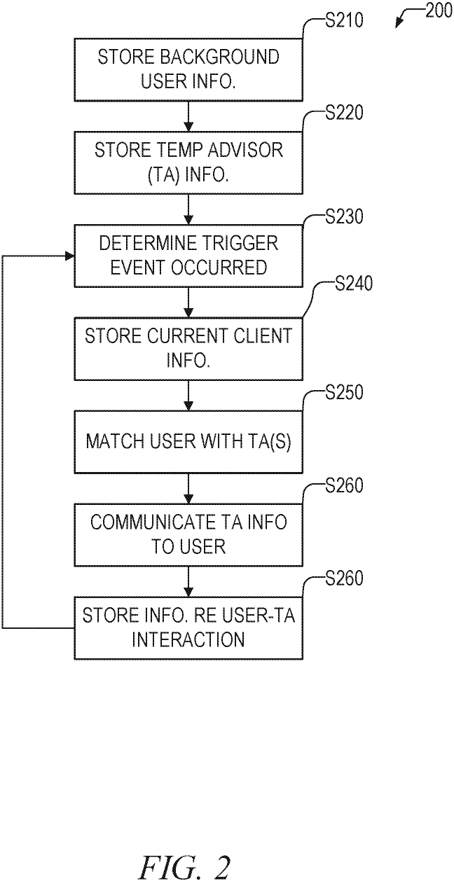

FIG. 2 is a flowchart that illustrates a process flow 200 that may be utilized in the sy stem shown and described above with respect to FIG. 1. In operation S210, the user’s 10 background information 132 may be collected and stored in a memory of the service provider’s 100 system. Such information may include user contact information, information related to the user’s accounts and investments 180 and may be collected via a survey, company representative, questionnaire, or any other suitable mechanism. Similarly, in operation S220, similar background information may be collected with respect to various temporary advisors 20 that may provide advisor services on behalf of the service provider 100. This information may be manually entered, e.g, by the temporary advisor 20 or it may be determined by the system (e.g., information such as advisor ratings, credentials, and the like).

In operation S230, when a trigger event occurs, some or all of a number of different activities may occur to provide temporary advisor assistance to the user 10. In operation S240, the event processor 170 may gather and store additional information 134 related to the current event or situation of the user 10, and, in operation S250, use the information stored in the user record, in combination with the matching engine 160 to find a good match of the user 10 with one or more temporary advisors 20. The user 10 may select the one or one of the temporary advisors presented by the service provider 100 to work with on the event or situation in an interaction. The user 10 may then contact the accepted temp orary advisor 20 or vice versa, and engage in communications and activities related to the event or situation. Once the interaction is complete and any recommendations or actions by the temporary advisor 20 have been communicated to the user, in operation S260, any subsequent user activities related to the interaction may be gathered and stored in the user record 130.

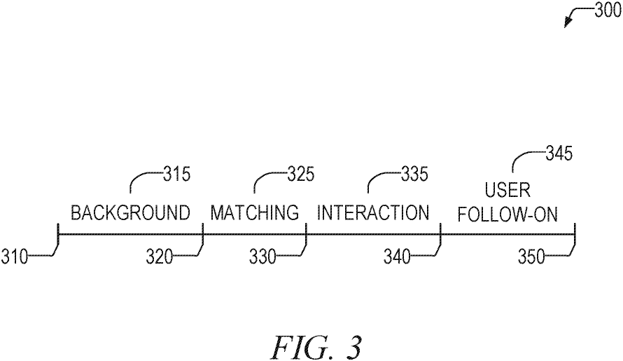

FIG. 3 is a timeline/state diagram 300 that illustrates the various states the user 10 and the temporary advisor 20 might go through. The service provider system may transition 310 into a background state 315 with a user 10 and temp orary advisor 20 based on the user 10 establishing a business relationship with the service provider 100, such as by opening an account or entering into a contractual relationship with the service provider for advisor services. Background information 132 may be provided to the sy stem that is related to the user. Similarly, during the background state 315, the temporary advisor 20 may establish information relevant to themselves in the temporary advisor database 140.

The sy stem may then transition 320 into a matching state 325 once a trigger event has been detected, the matching state utilizing the matching engine to select one or more temporary advisors 20 who might pair well with the user 10 to help deal with the event or situation. The system may then transition 330 into an interaction state 335 in which a user 10 has selected a temporary advisor 20 to work with and communications between the user 10 and temporary advisor 20 are established. A transition 340 at the conclusion of an interaction between the user 10 and temporary advisor 20 puts the system in a user follow-on activity state 345 during which the user 10 may choose to act (or not act) on actions recommended by the temporary advisor 20 and the system may store any information related to the user’s (in)actions. The user follow-on action state 345 concludes with completion of any user 10 follow-on actions 350.

### General Computer and Network Architecture

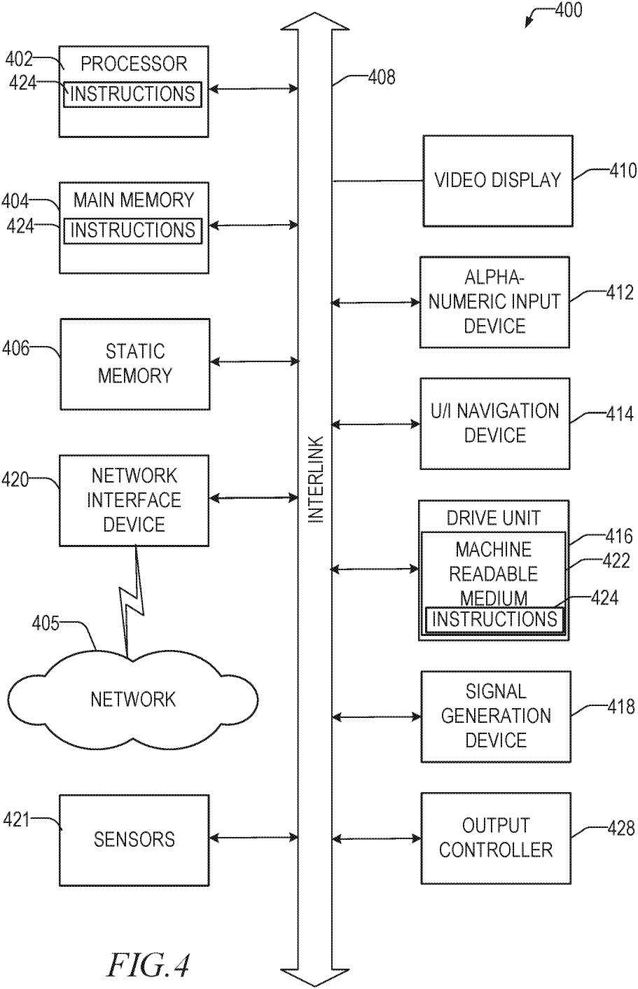

To describe some configurations in greater detail, reference is made to examples of hardware structures and interconnections usable in the designs of the present disclosure. FIG. 4 is a block diagram illustrating a machine 400 that may be a computer or computer sy stem on which various processes described herein may be performed. The machine 400 may form various parts or all of the service provider system 100 described above. Such a machine 400 may include a hardware processor 402 (e.g, a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example described herein, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g, universal serial bus (USB)), parallel, or other wired or wireless (e.g., infrared (IR), near field communication (NFC), etc.) controller connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 424 may further be transmitted or received over the communications network 405 using a transmission medium via the network interface device 420. The term “transmission medium” is defined herein to include any medium that is capable of storing encoding, or carrying instructions for execution by the machine, and includes digital or analog communications signals or other medium to facilitate communication of such software.

The machine 400 may communicate with one or more other machines 400 utilizing any one of a number of transfer protocols (e.g, frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g, Institute of Electrical and Electronics Engineers (IEEE) 402.11 family of standards known as Wi-Fi®, IEEE 402.16 family of standards known as WiMax®), IEEE 402.15.4 family of standards, a Long Term Evolution (LTE) family of standards, a Universal Mobile Telecommunications Sy stem (UMTS) family of standards, peer-to-p eer (P2P) networks, virtual private networks (VPN), or any other way of transferring data between machines 400. In an example, the network interface device 420 may include one or more physicaljacks (e.g., Ethernet, coaxial, or phone jacks) or one or more antennas to connect to the communications network 426.

In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

A wide variety of computing devices may constitute a machine 400, as described herein. The following list includes a variety of devices that may fit the definition of a machine 400: a personal data assistant (PDA), a cellular telephone, including a smartphone, a tablet computing device, a laptop computer, a desktop computer, a workstation, a server computer, a mainframe computer, and the like.

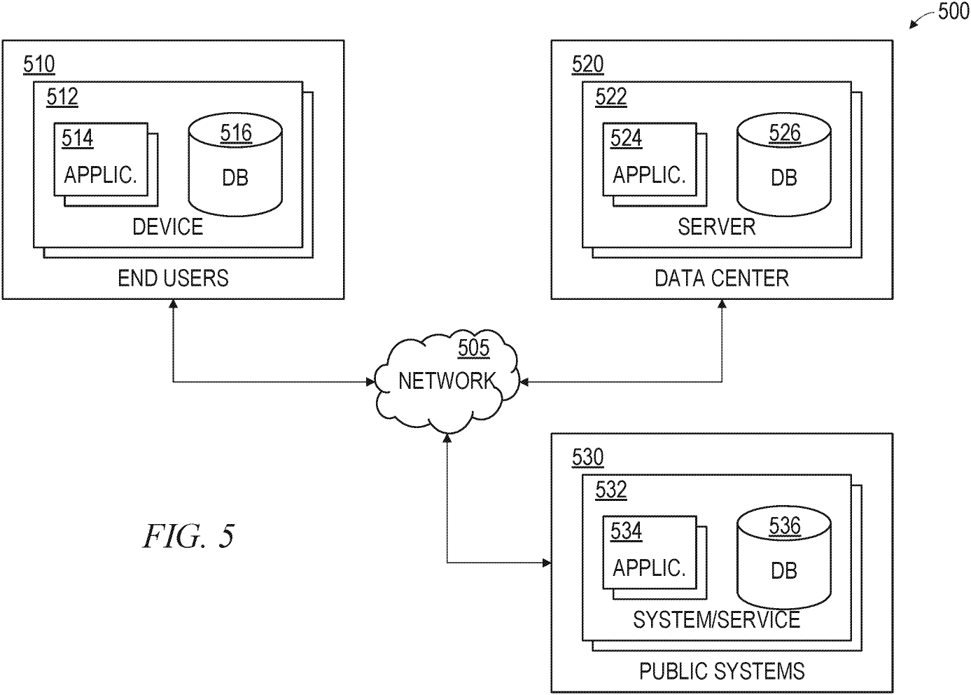

FIG. 5 is a block diagram of a distributed sy stem 500 that may include a client-server architecture or cloud computing sy stem. The sy stem 500 may be a sy stem 100 as described above. Distributed system 500 may have one or more end users 510. An end user 510 may have various computing devices 512, which may be machines 400 as described above. The end-user computing devices 512 may comprise applications 514 that are either designed to execute in a stand-alone manner, or interact with other applications 514 located on the device 512 or accessible via the network 405. These devices 512 may also comprise a data store 516 that holds data locally, the data being potentially accessible by the local applications 514 or by remote applications.

The system 500 may also include one or more data centers 520. A data center 520 may be a server 522 or the like associated with a service provider that an end user 510 may interact with. The service provider may be a computer service provider, as may be the case for a cloud services provider, or it may be a consumer product or service provider, such as a retailer. The data center 520 may comprise one or more applications 524 and databases 526 that are designed to interface with the applications 514 and databases 516 of end-user devices 512. Data centers 520 may represent facilities in different geographic locations where the servers 522 may be located. Each of the servers 522 may be in the form of a machine(s) 300.

The system 500 may also include publicly available systems 530 that comprise various systems or services 532, including applications 534 and their respective databases 536. Such applications 534 may include news and other information feeds, search engines, social media applications, and the like. The systems or services 532 may be provided as comprising a machine(s) 300.

The end-user devices 512, data center servers 522, and public systems or services 532 may be configured to connect with each other via the network 305, and access to the network by machines may be made via a common connection point or different connection points, e.g a wireless connection point and a wired connection. Any combination of common or different connections points may be present, and any combination of wired and wireless connection points may be present as well. The network 305, end users 510, data centers 520, and public systems 530 may include network hardware such as routers, switches, load balancers and/or other network devices.

Other implementations of the system 500 are also possible. For example, devices other than the client devices 512 and servers 522 shown may be included in the system 500. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 522.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAM s), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to be illustrative, and not restrictive. For example, the above-described examples (or one or more aspects/configurations thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it should not be used to interpret or limit the scop e or meaning of the claims.

Also, in the above Detailed Description, various features may be grouped together to streamline the disclosure. However, the claims cannot set forth every feature disclosed herein, as embodiments may feature a subset of said features. Further, embodiments may include fewer features than those disclosed in a p articular example. Thus, the following claims are hereby incorporated into the Detailed Description, with a claim standing on its own as a separate embodiment. The scope of the embodiments disclosed herein is to be determined with reference to the claims, along with the full scop e of equivalents to which such claims are entitled.

1. A computer-implemented method for providing assistance to a user of a service provider (SP), the method comprising, using a processor:
receiving and storing user background information for a user in a user database in a storage device of the SP, the background information comprising user account information that is accessible by the SP;
receiving and storing temporary advisor (TA) information for a plurality of TAs in a TA database in the storage device, the TA information including respective ratings for each of the plurality of TAs and respective weights; and
with a matching engine that uses the processor:
determining with a detection mechanism, an occurrence of a trigger event related to the user account information; and
in response to the determination of the occurrence of the trigger event:
storing current user information in the user database, wherein the current user information includes global positioning (GPS) information of the user; and
matching the user with one or more matched TAs of the plurality of TAs for an interaction with one of the one or more matched TAs based on a set of matching criteria that utilizes the background to create a match, the GPS information, the respective weights, and the respective ratings for each of the plurality of TAs;
causing presentation of a first user interface, the first user interface including:
information related to the one or more matched TAs for an interaction; and
a selector configured to receive an input from the user corresponding to a selection of the one or more matched TAs;
receiving an input corresponding to the selection of the one or more matched TAs;
receiving and storing interaction information related to an interaction with the selected TA, the interaction information corresponding to recommended activity to be performed by the user, the recommended activity relating to a recommendation from the one or more TAs;
causing presentation of a second user interface based on the interaction information and in response to receiving the selection of the one or more matched TAs, the second user interface including a selector engageable to perform the recommended activity;
detecting, with a detector, activity or inactivity of the recommended activity thereby identifying activity of the user in response to the interaction, wherein the identified activity is one of the inactivity of the recommended activity expected to be performed by the user based on pre-defined criteria or an occurrence of the recommended activity expected to be performed by the user based on pre-defined criteria;
updating the respective ratings for the one or more matched TAs according to an analysis of the interaction information and the activity of the user in response to the interaction; and
updating the weights for the one or more matched TAs using artificial intelligence, the artificial intelligence characterizing the match based on the inactivity of the recommended activity expected to be performed by the user based on the pre-defined criteria or the occurrence of the recommended activity expected to be performed by the user based on the pre-defined criteria, wherein the updated respective ratings are adjusted downwardly based on a non-occurrence of the recommended activity expected to be performed by the user based on the pre-defined criteria and the updated respective ratings are adjusted upwardly based on the occurrence of the recommended activity expected to be performed by the user based on the pre-defined criteria and the background information is stored prior to the trigger event.

2. The method of claim 1, wherein the user background information comprises identity, geographic, and SP account information of the user.

3. The method of claim 1, wherein the TA information comprises an area of expertise, and an amount of expertise, of the TAs.

4. The method of claim 3, wherein the matching criteria comprises the area of expertise, and the amount of expertise of the TAs, and the user background information or the current user information.

5. The method of claim 3, wherein each of the matching criteria has an associated weight.

6. The method of claim 1, wherein the method further comprises sending a notification of the selected TA to the SP.

7. The method of claim 1, wherein the trigger event is at least one of an account status change, a user contact of a business institution, or a timer expiration.

8. The method of claim 1, wherein the trigger event is determined based on information received by the SP from a third party over a network interface of the SP.

9. The method of claim 1, wherein the current user information comprises current location information of the user and calendar information of the user.

10-13. (canceled)

14. The method of claim 1, wherein the TA is an automated TA.

15. A service provider (SP) system comprising:
a hardware processor; and
a non-volatile storage device connected to the hardware processor comprising instructions that, when executed on the processor, configure the processor to:
receive and store in the non-volatile storage device user background information for a user in a user database in a storage device of the SP, the background information comprising user account information that is accessible by the SP; and
receive and store in the non-volatile storage device temporary advisor (TA) information for a plurality of TAs in a TA database in the storage device, the TA information including respective ratings for each of the plurality of TAs and respective weights;
a matching engine that uses the hardware processor of the SP to:
determine with a detection mechanism, an occurrence of a trigger event related to the user account information, and
in response to determination of the occurrence of the trigger event:
store current user information in the user database, wherein the current user
information includes global positioning (GPS) information of the user; and
match the user with one or more matched TAs of the plurality of TAs for an interaction with one of the one or more matched TAs based on a set of matching criteria that utilizes the background to create a match, the GPS information, the
respective weights, and the respective ratings for each of the plurality of TAs; cause presentation of a first user interface, the first user interface including:
information related to the one or more matched TAs for an interaction; and
a selector configured to receive an input from the user corresponding to a selection of the one or more matched TAs;
receive an input corresponding to the selection of the one or more matched TAs;
receive and store, in the storage device, interaction information related to an interaction with the selected TA, the interaction information corresponding to recommended activity to be performed by the user, the recommended activity relating to a recommendation from the one or more TAs;
cause presentation of a second user interface based on the interaction information and in response to receiving the selection of the one or more matched TAs, the second user interface including a selector engageable to perform the recommended activity;
detect, with a detector, activity or inactivity of the recommended activity thereby identifying activity of the user in response to the interaction, wherein the identified activity is one of the inactivity of the recommended activity expected to be performed by the user based on pre-defined criteria or an occurrence of the recommended activity expected to be performed by the user based on pre-defined criteria;
update the respective ratings for the one or more matched TAs according to an analysis of the interaction information and the activity of the user in response to the interaction; and
update the weights for the one or more matched TAs using artificial intelligence, the artificial intelligence characterizing the match based on the inactivity of the recommended activity expected to be performed by the user based on the pre-defined criteria or the occurrence of the recommended activity expected to be performed by the user based on the pre-defined criteria, wherein the updated respective ratings are adjusted downwardly based on a non-occurrence of the recommended activity expected to be performed by the user based on the pre-defined criteria and the updated respective ratings are adjusted upwardly based on the occurrence of the recommended activity expected to be performed by the user based on the pre-defined criteria and the background information is stored prior to the trigger event.

16. The system of claim 15, further comprising an activity detector to determine when the user has followed a TA recommendation, and when so, modify at least one of the matching criteria, a weighting of a matching criterion, or an advisor rating.

17. The system of claim 15, wherein the processor is further configured to send a notification of the selected TA to the SP.

18. A non-transitory computer-readable storage medium, the computer-readable storage medium including instructions that when executed by a processor, cause the processor to:
receive and store in a storage device user background information for a user in a user database in a storage device of a service provider (SP), the background information comprising user account information that is accessible by the SP; and
receive and store in the storage device temporary advisor (TA) information for a plurality of TAs in a TA database in the storage device, the TA information including respective ratings for each of the plurality of TAs and respective weights;
a matching engine that uses the processor of the SP to:
determine with a detection mechanism, an occurrence of a trigger event related to the user account information; and
in response to determination of the occurrence of the trigger event:
store current user information in the user database, wherein the current user
information includes global positioning (GPS) information of the user; and
match the user with one or more matched TAs of the plurality of TAs for an interaction with one of the one or more matched TAs based on a set of matching criteria that utilizes the background to create a match, and the GPS information, the respective weights, and the respective ratings for each of the plurality of TAs;
cause presentation of a first user interface, the first user interface including:
information related to the one or more matched TAs for an interaction; and
a selector configured to receive an input from the user corresponding to a selection of the one or more matched TAs;
receive an input corresponding to the selection of the one or more matched TAs;
receive and store, in the storage device, interaction information related to an interaction with the selected TA, the interaction information corresponding to recommended activity to be performed by the user, the recommended activity relating to a recommendation from the one or more TAs;
cause presentation of a second user interface based on the interaction information and in response to receiving the selection of the one or more matched TAs, the second user interface including a selector engageable to perform the recommended activity;
detect, with a detector, activity or inactivity of the recommended activity thereby identifying identify activity of the user in response to the interaction, wherein the identified activity is one of the inactivity of the recommended activity expected to be performed by the user based on pre-defined criteria or an occurrence of the recommended activity expected to be performed by the user based on pre-defined criteria; and
update the respective ratings for the one or more matched TAs according to an analysis of the interaction information and the activity of the user in response to the interaction using artificial intelligence, the artificial intelligence characterizing the match based on the inactivity of the recommended activity expected to be performed by the user based on the pre-defined criteria or the occurrence of the recommended activity expected to be performed by the user based on the pre-defined criteria, wherein the updated respective ratings are adjusted downwardly based on a non-occurrence of the recommended activity expected to be performed by the user based on the pre-defined criteria and the updated respective ratings are adjusted upwardly based on the occurrence of the recommended activity expected to be performed by the user based on the pre-defined criteria and the background information is stored prior to the trigger event.

19. The storage medium of claim 18, wherein the instructions further cause the processor to determine when the user has followed a TA recommendation, and when so, modify at least one of the matching criteria, a weighting of a matching criterion, or an advisor rati ng.
